(19) United States
(12) Patent Application Publication
(10) Pub. No.: US 2004/0266917 A1
(43) Pub. Date: Dec. 30, 2004

(54) Polyester-based compositions having improved thermomechanical properties and process to produce said compositions

(76) Inventor: Jean Luc Lepage, Saint Fons (FR)

Correspondence Address: DARBY & DARBY P.C., P. O. BOX 5257, NEW YORK, NY, 10150-5257, US

(21) Appl. No.: 10/182,029

(22) PCT Filed: Mar. 28, 2001
(86) PCT No.: PCT/BR01/00030

(30) Foreign Application Priority Data
Mar. 29, 2000 (FR) 00/03965

(51) Int. Cl. C08K 7/16; C08K 3/18; C08K 3/22; C08K 3/34

(52) U.S. Cl. 523/223; 524/493; 524/497; 524/430

(57) ABSTRACT

The present invention refers to polyester-based compositions having improved thermomechanical properties, comprising finely divided mineral particles. These compositions are particularly useful for manufacturing bottles. The present invention further refers to a process for producing said compositions. The compositions comprise a polyester-based matrix and nanometric-sized particles.

The present invention refers to polyester-based compositions presenting improved thermomechanical properties, comprising fine sized mineral particles. These compositions are especially useful for manufacturing bottles. The present invention further refers to a process to produce such compositions.

Polyesters, especially polyethylene terephthalate, are thermoplastic polymers widely used for the production of molded or extruded articles. They are generally employed as yarns or fibers, injection molded articles, films (extruded and drawn articles) or vessels for example obtained through an extrusion-blow process. The properties of the articles produced are greatly dependent on the thermomechanical properties of the polymer, such as the modulus, the flexibility, the glass transition temperature, the heat distortion under load.

The heat distortion under load is an important feature for the use of polyesters as bottles, more particularly for bottles meant to contain beverages. For preservation and food higiene purposes, certain beverages must de hot-filled into the bottles, and eventually in the absence of oxygen. This is particularly the case for fruit juices, pasteurized or sterilized products, especially dairy products, tea or coffee beverages, beer. If the filling temperature is too high, and/or if the liquid remains too long in the bottle over a certain temperature, the latter deforms. This shortcoming can limit the field of use of the polyester, and particularly of polyethylene terephthalate, for containing beverages. Hence, certain beverages cannot be disposed in polyethylene terephthalate bottles, or cannot except under limited temperature conditions.

Continuous attempts are being made to elaborate polyesters, polyester-based compositions or processes for forming polyester articles, such that thermomechanical properties are improved, particularly such that the heat distortion under load is improved.

Therefor, a first solution may consist in utilizing a polyethylene naphthalate instead of a polyethylene terephthalate, or copolymers comprising naphthalic and terephthalic units. This solution is however costly, and is not industrially used except for very specific applications.

Another solution consists in modifying the process of forming the bottles in order to over-crystallize the polymer. The process according to this solution is generally called “thermofixing”. In short, it consists in crystallizing a polyethylene terephthalate bottle by modifying the blowing operations. The carrying out of this process requires however an important modification of the bottle production lines and hence requires important investments. The necks of the bottles obtained according to this process are crystallized and thus lose their transparency. This may constitute a visual defect.

The object of the present invention is to propose fillers which may be utilized to improve thermomechanical properties of polyesters, especially easily incorporable fillers, well dipersed in the matrix. It is a further object to propose a process to produce polyester-based compositions presenting improved thermomechanical properties.

To this avail, the present invention proposes a polyester-based composition characterized in that it comprises a polyester-based matrix and nanometrical-sized mineral particles, the shape factor ranging between 1 and 10, at a weighted concentration ranging between 0.01% and 25%.

The matrix of the composition may be full polyester-based. It may be constituted of a single polymer, the polyester, or of a polymer blend where at least one mais component is a polyester. It may also consist of, as an amorphing agent, a copolymer where most of the repeating units comprise ester functions.

Polyesters adequate for carrying out the invention are generally obtained through polycondensation of diols and dicarboxylic acids or esters of dicarboxylic acids.

Among the diols adequate to carry out the invention, ethylene glycol, diethylene glycol, propylene glycol, 1,3-propanediol, 1,4-butanediol, 1,3-butanediol, 2,2-dimethylpropanediol, neopentyl glycol, 1,5-pentanediol, 1,2-hexanediol, 1,8-octanediol, 1,10-decanediol, 1,4-cyclohexanedimethanol, 1,5-cyclohexanedimethanol, 1,2-cyclohexanedimethanol, or mixtures thereof can be mentioned.

Among the dicarboxylic acids adequate for carrying out the invention, terephthalic acid, isophthalic acid, orthophthalic acid, 2,5-naphthalene dicarboxylic acid, 2,6-naphthalene dicarboxylic acid, 1,3-naphthalene dicarboxylic acid, 2,7-naphthalene dicarboxylic acid, methyl terephthalic acid, 4,4′-diphenyldicarboxylic acid, 2,2′-diphenyldicarboxylic acid, 4,4′-diphenylether dicarboxylic acid, 4,4′-diphenylmethanedicarboxylic acid, 4,4′-diphenylsulfonedicarboxylic acid, 4,4′-diphenylisopropylidene-dicarboxylic acid, sulfo-5-isophthalic acid, oxalic acid, succinic acid, adipic acid, sebacic acid, azelaic acid, dodecanedicarboxylic acid, dimer acid, maleic acid, fumaric acid, and all aliphatic diacids, cyclohexane dicarboxylic acid can be mentioned.

The dicarboxilic acids can be introduced in the polycondensation medium in an esterified form, for example via methoxy or via ethoxy.

The preferred polyesters for carrying out the invention are, polyethylene terephthalate, polytrimethylene terephthalate, polybutylene terephthalate, polynaphtha-lene terephthalate, copolymers and mixtures thereof.

The nanometrical mineral particles according to the invention confer improved mechanical properties to the composition relative to an identical composition not comprising said particles. The heat distortion under load is noticeably improved.

The shape factor of a particle is defined as the ratio between the largest dimension and the smallest dimension of a particle. For example, if the particles are platelet-shaped, the shape factor is defined by the ratio between the length of the platelets and their width. If the platelets are needle-shaped, their shape factor is defined by the ratio between the length of the needle and the cross-sectional diameter of the needle. If the particles have a substantially spherical shape, the shape factor equals 1.

The particles according to the invention present a low shape factor, ranging between 1 and 10. The shape factor is preferably between 1 and 2.

By nanometric-sized particles, it is meant that the small dimension is lower than 200 nm, and the large parameter is lower than 2000 nm, preferably lower than 400 nm. According to a preferred embodiment, the small dimension is lower than 100 nm and the large dimension is lower than 200 nm.

According to an advantageous embodiment of the invention, the particles are substantially spherical-shaped with an average diameter lower than or equal to 200 nm. The average diameter preferably ranges between 5 and 100 nm.

The mineral particles are preferably chosen from metal oxide-based particles, for example, silica, titanium dioxide, alumina, zirconia. It may comprise a surface treatment or coating. Such treatments are meant, for example, to improve the particle dispersion in the polymer, to protect the particles against deterioration, or to protect the polymer from degradations through contact with the particles. All the known surface treatments and coatings known in the field of polymer fillers, particularly those known and used as fillers having dimensions above those referring to the invention, can be used. One can use, for example, titanium dioxide particles partially or fully coated with a silica-based compound.

Silica-based particles are particularly adequate for carrying out the invention. Any type of known silica can be employed in the polyester-based compositions. For example, fumed silicas, combustion silicas, precipitated silicas, silica sols. The use of sols is particularly adequate for the obtention of a composition having a good particle dispersion.

The weighted concentration of particles in the composition ranges between 0.1 and 20%. It preferably ranges between 5 and 15%.

Any method for introducing a compound into a composition may be employed. A first method consists in introducing the particles into the polyester reaction medium, usually before the polymerization has begun. The polymerization is then carried out in the presence of the particles. The particles can be introduced as a powder or as a dispersion into a liquid medium.

A second method consists in introducing the particles as a powder into the molten polyester and then shearing the mixture in order to obtain a homogeneous dispersion. This operation can for example be carried out by means of an extruder, single or twin screw.

A third method consists in introducing the particles as a master batch in the molten polyester. The blending can be effected by any of the above-mentioned methods. The introduction of the master batch in the polymer can be effected by means of an extruder.

According to a particularly advantageous embodiment of the invention, the particles are introduced as a sol into the polymer reaction medium. The sol can be for example an aqueous or glycolic sol. Silica sols are particularly adequate for this embodiment.

A process to prepare the compositions according to this embodiment comprises for example the following steps:

a) Introducing in a mixture with water at least one diol with at least one dicarboxylic acid or a dicarboxylic acid ester of a silica sol where the particles have an average diameter smaller than or equal to 200 nm

b) Esterifying or transesterifying the acid or the acid ester with the diol,

c) Polycondensing under vacuum the esterification product,

d) Forming the final product.

Except for the introduction of the silica sol into the monomer mixture, the process for producing the compositions is classical. Processes are described for example in Les techniques de l'inqénieur J 6 020, 2151-2160. The process is in no way the object of any limitation of the scope of the invention.

Esterification or transesterification step b) is a step commonly carried out within the industrial polyester manufacturing procedures. For example, two routes are mainly employed for producing poly(ethylene terephthalate).

The first obtention route is the so called “methyl terephthalate” (DMT) route. It comprises a transesterification reaction. Molten DMT is solubilized in ethylene glycol (EG) present in excess, the molar ratio of EG/DMT being of about 1.9 to 2.2, and the reaction is conducted at atmospheric pressure and temperatures of about 130° C. to 250° C. The presence of a catalyst, for example manganese acetate, is necessary. Methanol released during the reaction is eliminated through distillation. The ethylene glycol present in excess is eliminated through evaporation after the transesterification reaction. The catalyst, which is also a polyester degradation catalyst, is blocked by means of phosphorous compounds after the reaction. The product resulting from the transesterification is a blend of bis-hydroxyethylterephthalate (BHET) and oligomers.

The second route is the so called “direct esterification”. It comprises an esterification reaction between terephthalic acid and ethylene glycol. It is carried out at temperatures of 130° C. to 280° C. Terephthalic acid, molten at such temperatures is not soluble in ethylene glycol but is in in the ester product of the reaction. The solubilization of the reactant in the medium is however progressive. Ethylene glycol is present at a molar ratio of EG/terephthalic acid of about 1 to 1.5. From this raction results a mixture of oligomers having terephthalic acid or hydroxyethyl terephthalate.

The utilization of these processes has been the object of numerous studies described in literature. The conditions indicated hereabove should not be regarded as limiting the scope of the present invention.

The subsequent polycondensation steps are usually catalyzed through metallic compounds, for example antimonium, titanium or germanium compounds. They can be catalyzed by any polyester polycondensation catalyst. They are usually carried out at low pressures, in order to favor the elimination of ethylene glycol formed during the condensation reaction.

The polymer is then formed into the final product, for example by extruding a strand through an orifice, cooling, and granulating. The formation is usually preceded by a molten phase filtration. The molten phase polycondensation and final product formation steps can be followed by a solid phase post-condensation step.

The compositions, for example in a granulated form, can be formed into molded articles. They can more particularly be used in the form of bottles. All the processes for manufacturing bottles from thermoplastic polymers are adequate for the invention. The extrusion-blow molding process is in general preferred.

The bottles thus produced can be filled with liquids at high temperatures and/or with liquids remaining hot in the bottle during long periods of time.

Other details or advantages of the presente invenção will become more apparent from the following examples, set forth for indicative purposes only.

Different polyester-based compositions were synthesized, the following characteristics of which are measured:

Viscosity index (VI, in ml/g); measured according to ISO 1628/5 standard; measured in a solution of 0.5% of the composition in a 50/50 by weight mixture of phenol/orthodichlorobenzene, at 25° C. The polymer concentration used for the calculations of the viscosity index is the actual polymer concentration, considering the presence of particles in the composition.

Molecular mass in absolute weight (g/mole); determined by Gel Permeation Chromatography (GPC).

Color according to the CIE lab system: measurements of l⁺, a⁺, b⁺.

Thermomechanical properties: modulus at 23° C., Modulus at 160° C., Glass transition temperature (Tg). Dynamical measurements (Dynamical mechanic analysis) on an RSA apparatus, using 40⁺4⁺2 mm samples, after drying and crystallization at 130° C. under vacuum during 16 hours.

Heat distortion under load (HDT), evaluated according to ISO 75-2 standard.

Crystallization: the dry polymer is plastified at 290° C. such as to destroy any crystallization germ. The molten product is injected in a series of molds where the thickness varies progressively whereby to obtain plates at thicknesses between 2 and 6 mm. The mold wall temperature is adjusted at 37° C. The thickness at which a slight disturbance corresponding to the beginning of crystallization occurs is registered.

### EXAMPLE 1

Into a 7.5 liter polymerization reactor, permitting the obtention of 3 kg of polymer through polycondensation, equipped with an agitator provided with a torsiometer to monitor the viscosity of the reaction medium, several introduction sieves, a distillation column to eliminate water formed during the esterification, as well as the excess of ethylene glycol, and a vacuum circuit for the polycondensation step, the following are loaded:

2656 g of terephthalic acid (16.0 moles)

1190 g of ethylene glycol (19.2 moles)

384 g of an aqueous sol of 50 nm diameter nanoparticles of silica, commercialized by Hoechst under the tradename Klebosol® 40R50, corresponding to 143.6 g of silica.

After a nitrogen purge, the reaction medium is heated to 275° C. under agitation and under 6.6 bar absolute pressure.

The esterification period is defined as the necessary time for the distillation of the water.

The esterification time is 66 minutes.

The pressure is then brought to atmospheric pressure along a period of 20 minutes.

A solution of antimony oxide is introduced into the reaction medium (250 ppm antimony, based on the polymer).

The pressure is maintained during 20 minutes at atmospheric pressure, before a progressive application of vacuum from 1 bar to less than 1 mm mercury along a period of 90 minutes. The distillation column is then bypassed for direct vacuum to be applied as soon as the pressure reaches 20 mm mercury.

The reaction mass is brought to 285° C. as soon as the pressure goes under 1 mm mercury.

The polycondensation time is defined as the time required to reach the desired viscosity level parting from the moment where pressure is under 1 mm mercury.

The polycondensation time is 32 minutes.

Once the desired viscosity level is attained, agitation is interrupted and the reactor is pressurized to 3 bar to discharge and granulate the obtained polymer.

The polymer granules are dried during 15 hours at 50° C.

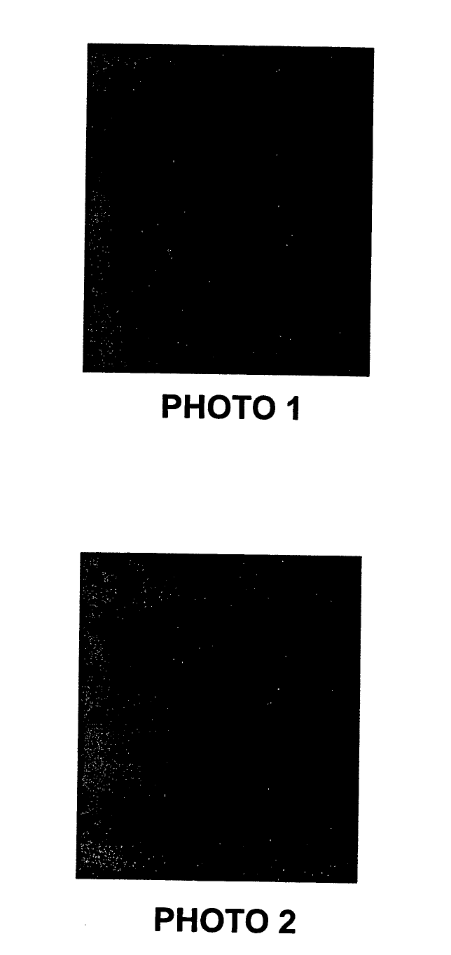

Photographs taken with an Electronic Transmission Microscope are shown in FIG. 1. Photo 1 is taken at an about 2.10⁴ magnification and photo 2 is magnified at about 10⁵.

### EXAMPLE 2

### Comparative Example

A polymer is prepared according to example 1, except that the nanoparticles of silica are not added.

The esterification time is 54 minutes.

The polycondensation time is 67 minutes.

### EXAMPLE 3

A polymer is prepared according to example 1, except that the aqueous silica particle sol is added together with the antimonium oxide solution.

The esterification time is 87 minutes.

The polycondensation time is 59 minutes.

### EXAMPLE 4

A polymer is prepared according to example 1, except that instead of the 2656 g of terephthalic acida, the following is added:

2592 g of terephthalic acid

63.7 g of isophthalic acid (corresponding to 2.4 mole % of the amount of acid)

The esterification time is 65 minutes.

The polycondensation time is 59 minutes.

### EXAMPLE 5

A polymer is prepared according to example 1, except that the aqueous silica particle sol is an aqueous sol of 25 nm diameter silica nanoparticles, comercialized by Hoechst under the tradename Klebosol® 40R50.

The esterification time is 68 minutes.

The polycondensation time is 32 minutes.

### EXAMPLE 4

A polymer is prepared according to example 1, except that the following compounds are added:

2592 g of terephthalic acid

63.7 g of isophthalic acid (corresponding to 2.4 mole % of the amount of acid)

37 g of ethylene glycol

1306 g of a glycolic silica sol at 11.8% by weight silica, the sol being synthetized through a Stöber type process, the silica particles having a 50 nm diameter.

The esterification time is 54 minutes.

The polycondensation time is 73 minutes.

### EXAMPLE 7

A polymer is prepared according to example 1, except that instead of the 2656 g of terephthalic acid, the following is added:

2497 g of terephthalic acid

159 g of isophthalic acid (corresponding to 6 mole % of the amount of acid)

The esterification time is 61 minutes.

The polycondensation time is 68 minutes.

The features of the compositions according to examples 1 through 7 are shown in table I.

TABLE I

| | VI | Mw | | | | | Modulus | Modulus | Tg | Crystal- |
|---|---|---|---|---|---|---|---|---|---|---|
| Ex. | (ml/g) | g/mole | l⁺ | a⁺ | b⁺ | HDT | 23° C. (Mpa) | 160° C. (Mpa) | (Mpa) | lization (mm) |
| 1 | 67.0 | 37900 | 54 | −0.4 | 67° C. | 1165 | 82 | 107 | | |
| 2 | 79.5 | | 72 | −0.9 | 59 | 988 | 61 | 99 | 4 | |
| 3 | 72.1 | 41000 | 75 | −1.0 | | | | | | |
| 4 | 71.1 | | 66 | −2.3 | | | | | 3 | |
| 5 | 62.4 | 33700 | 59 | −1.5 | 67 | 1195 | 88 | 107 | | |
| 6 | 68.5 | | 78 | −2.7 | | 1015 | 65 | 103 | 4.5 | |
| 7 | 74.8 | | 71.0 | −0.7 | | | | | 6 | |

### EXAMPLE 8

100 kg of a composition are prepared according to example 4 in a double vessel reactor at 200° C., with 1.9 mole % isophthalic acid.

### EXAMPLE 9

A composition is prepared according to example 8, except that the nanoparticles of silica are not added.

The compositions of examples 8 and 9 are molded into bottles, through injection/blowing in an integrated ABS F100 machine. The preforms weigh 32 g, the bottles have a 600 ml capacity.

A hot-filling test is carried out on these bottles; the bottles are filled at different temperatures and the their volume variation is measured. The higher the variation, worse is the composition.

Table II shows the filling temperature (° C.) and the deformation (ml) for a bottle obtained from the compositions according to examples 8 and 9.

TABLE II

| Temperature | Example 8 | Example 9 |
|---|---|---|
| 70 | 76.6 | 50.6 |
| 75 | 109.6 | 70.3 |
| 80 | 149.1 | 129.1 |
| 85 | 205.8 | 176.6 |

1-16. (cancelled)

17. Polyester-based composition having improved thermomechanical properties, comprising a polyester-based matrix and nanometrical-sized mineral particles, having a shape factor comprised between 1 and 10, at a weighted concentration within 0.01 and 25%.

18. The composition of claim 1, wherein the particles are substantially spherical-shaped having a diameter under or equal to 200 nm.

19. The composition of claim 2, wherein the average diameter of the particles is between 5 and 100 nm.

20. The composition of claim 1, wherein the particles are based on metal oxides.

21. The composition of claim 4, wherein the particles are based on a compound selected from the group consisting of silica, titanium dioxide, zirconia and alumina.

22. The composition of claim 5, wherein the particles are based on silica and the composition is obtained by introducing a silica sol within the polyester synthesis medium.

23. The composition of claim 6, wherein the silica sol is an aqueous or glycolic sol.

24. The composition of claim 1, wherein the polyester is selected from the group consisting of polyethylene terephthalate, polytrimethylene terephthalate, polybutylene terephthalate, polynaphthalene terephthalate and mixtures and copolymers based on these polyesters.

25. The composition of claim 1, wherein the polyester contains an amorphing agent.

26. The composition of claim 9, wherein the amorphing agent is a comonomer of the polyester.

27. The composition of claim 10, wherein the comonmer is selected from the group consisting of isophthalic acid, 1,4-cyclohexanedimethanol, diethylene glycol and mixtures thereof, and wherein the comonomer represents between 1 and 20 moles % of the repeating units in the polyester.

28. A process for producing a polyester-based composition, comprising the following steps:
a) Introducing in a mixture with water at least one diol with at least one dicarboxylic acid or a dicarboxylic acid ester of a silica sol where the particles have an average diameter smaller than or equal to 200 nm
b) Esterifying or transesterifying the acid or the acid ester with the diol
c) Polycondensing under vacuum the esterification product
d) Forming the final product

29. The process of claim 12, wherein step c is carried out in the presence of an antimonium- or titanium-based catalyst.

30. An article produced by the process of claim 12.
